(19) United States
(12) Patent Application Publication
(10) Pub. No.: US 2013/0091423 A1
(43) Pub. Date: Apr. 11, 2013

(54) Method and Apparatus for Checking a Structure Conformity for a Piece Of Development Documentation with at Least One Development Document

(71) Applicant: Siemens Aktiengesellschaft, Munchen (DE)

(72) Inventors: Andreas Dautovic, Pucking (AT); Christian Korner, Bergen (DE); Reinhold Plosch, Linz (AT); Matthias Saft, Olching (DE)

(73) Assignee: Siemens Aktiengesellschaft, Munchen (DE)

(21) Appl. No.: 13/646,374

(22) Filed: Oct. 5, 2012

(30) Foreign Application Priority Data
Oct. 11, 2011 (DE) 102011084281.0

(51) Int. Cl. G06F 17/24

(52) U.S. Cl. 715/255

(57) ABSTRACT

A method and an apparatus for checking a structure conformity for a piece of development documentation with at least one development document are disclosed. The method may include the following steps: the at least one development document from the development documentation is read in and a document structure for the development document that has been read in is captured by a capture unit, and discrepancies in the captured document structure from a predetermined document structure are ascertained by a checking unit by using prescribed criteria for checking the structure conformity of the development documentation.

### CROSS-REFERENCE TO RELATED APPLICATIONS

This application claims priority to DE Patent Application No. 2011 084 281.0 filed Oct. 11, 2011. The contents of which is incorporated herein by reference in its entirety.

### TECHNICAL FIELD

This disclosure relates to a method and an apparatus for checking a structure conformity for a piece of development documentation with at least one development document.

### BACKGROUND

The approaches to a solution for checking a structure conformity for a piece of software documentation which are currently generally known and in existence are based on a manual check on the software documentation.

There is a primary dependency on the experience of experts who check the software documentation during correction. This involves the documents being read individually or in teams by the experts, usually in a structured manner, more or less completely and being checked for structure conformity.

This manual check is frequently assisted by the use of general or company-specific checklists. The potential problems which the check identifies in the documents from the software documentation are subsequently discussed and documented by expert assessors. The overall result obtained, besides a list of the identified errors and potential sources of error, is usually a quality appraisal for the text of the software documentation. In some case, this result is complemented by a list containing suggestions for improvement and recommendations.

The technical approaches that have existed to date allow only restricted document content checks and are furthermore usually able to be applied only to particular document types, such as requirements documents or test schedules for software systems.

Conventional software-based analysis tools and tools for electronic text and language analysis provide only a rudimentary lexical or linguistic check for documents.

DE 10 2006 046 203 A1 describes a method for the computer-aided assessment of software source code. The method involves the software source code being analyzed by taking account of parameters, comprising coding rules and/or coding metrics, with the analysis result ascertained being errors detected in the software source code. The detected errors are classified by assigning each of them to at least one error class from a plurality of error classes. In this case, each error class has an associated specification which can be determined by using a user interface and which describes the errors in the respective error class. Those error classes which have detected errors associated with them are output by using a user interface. In this case, different types of errors contained in the software source code can be detected and handled. The method described therein also comprises error detection methods from classical code analysis.

### SUMMARY

In one embodiment, a method for checking a structure conformity for a piece of development documentation with at least one development document may comprise: the at least one development document from the development documentation is read in and a document structure for the development document that has been read in is captured by a capture unit; and discrepancies in the captured document structure from a predetermined document structure are ascertained by a checking unit by using prescribed criteria for checking the structure conformity of the development documentation.

In a further embodiment, the discrepancies found in the captured document structure are output as an error list using appropriate error messages. In a further embodiment, the discrepancies found in the captured document structure are shown by annotations in the development document. In a further embodiment, the discrepancies found in the captured document structure are output during editing of the development documentation. In a further embodiment, a check on a content of the development document is used as one of the prescribed criteria. In a further embodiment, a check on a version history of the development document is used as one of the prescribed criteria. In a further embodiment, a check on a list of contents for the development document is used as one of the prescribed criteria. In a further embodiment, the prescribed criteria for checking are matched to a need for the development documentation. In a further embodiment, a check on a structure component of the development document is used as one of the prescribed criteria. In a further embodiment, the criteria for checking are selected on the basis of a characteristic of the development documentation. In a further embodiment, the criteria for checking are selected on the basis of a characteristic of a development project associated with the development documentation. In a further embodiment, the predetermined document structure used is a document structure for a piece of software documentation.

In another embodiment, an apparatus for checking a structure conformity for a piece of development documentation with at least one development document may include: a capture unit for reading in the at least one development document from the development documentation and for capturing a document structure for the development document that has been read in; and a checking unit for ascertaining discrepancies in the captured document structure from a predetermined document structure by using stipulated criteria for checking the structure conformity of the development documentation.

In a further embodiment, the apparatus has an output unit for outputting the discrepancies found in the form of an error list using appropriate error messages. In a further embodiment, the apparatus has an output unit for showing the discrepancies found in the extracted document structure by annotations in the development document.

### BRIEF DESCRIPTION OF THE DRAWINGS

Example embodiments will be explained in more detail below with reference to figures, in which:

FIG. 1 shows an illustration of a flowchart of a method according to an example embodiment;

FIG. 2 shows an illustration of a program flowchart of a method according to an example embodiment;

FIG. 3 shows an illustration of a document model of the method according to an example embodiment;

FIG. 4 shows an illustration of a flowchart of the method according to an example embodiment;

FIG. 5 shows an illustration of an apparatus according to an example embodiment; and

FIG. 6 shows an illustration of an apparatus according to another example embodiment.

### DETAILED DESCRIPTION

Some embodiments provide a method which takes rules pertaining to the structure of a piece of development documentation as a basis for allowing an automated check on the structure conformity of documents from the development documentation for large to very large software systems.

For example, some embodiments provide a method for checking a structure conformity for a piece of development documentation with at least one development document, having the following steps: the at least one development document from the development documentation is read in and a document structure for the development document that has been read in is captured by a capture unit, and discrepancies in the captured document structure from a predetermined document structure are ascertained by a checking unit by using prescribed criteria for checking the structure conformity of the development documentation.

Certain embodiments are based on the concept of document guidelines being observed as an indispensible prerequisite for achieving explicitly or implicitly defined quality objectives for software documentation. Such a method accordingly makes a significant contribution to improving the formal and structural quality of the development documents from the development documentation for software systems.

Some embodiments of the method for checking the structure conformity and improving the formal quality of documents in software systems allow a large number of documents to be checked, the content of which usually grows considerably during the life of a software system and has a large number of problems, i.e., potentially erroneous passages in the documents. As a result, the method may allow the ascertained problems in the documentation to be automatically assessed, associated and solved, and allows a software solution to be created in an accelerated fashion in a defined quality, particularly with a defined documentation quality.

In one embodiment of the method, the discrepancies found in the captured document structure are output as an error list using appropriate error messages.

In one embodiment of the method, the discrepancies found in the captured document structure are shown by annotations in the development document.

In one embodiment of the method, the discrepancies found in the captured document structure are output during editing of the development documentation.

In one embodiment of the method, a check on a content of the development document is used as one of the prescribed criteria.

In one embodiment of the method, a check on a version history of the development document is used as one of the prescribed criteria.

In one embodiment of the method, a check on a list of contents for the development document is used as one of the prescribed criteria.

In one embodiment of the method, the prescribed criteria for checking are matched to a need for the development documentation.

In one embodiment of the method, a check on a structure component of the development document is used as one of the prescribed criteria.

In one embodiment of the method, the criteria for checking are selected on the basis of a characteristic of the development documentation.

In one embodiment of the method, the criteria for checking are selected on the basis of a characteristic of a development project associated with the development documentation.

In one embodiment of the method, the predetermined document structure used is a document structure for a piece of software documentation.

Other embodiments provide an apparatus for checking a structure conformity for a piece of development documentation with at least one development document, having a capture unit for reading in the at least one development document from the development documentation and for capturing a document structure for the development document that has been read in and having a checking unit for ascertaining discrepancies in the captured document structure from a predetermined document structure by using stipulated criteria for checking the structure conformity of the development documentation.

In one embodiment, the apparatus has an output unit for outputting the discrepancies found in the form of an error list using appropriate error messages.

In one embodiment, the apparatus has an output unit for showing the discrepancies found in the extracted document structure by annotations in the development document.

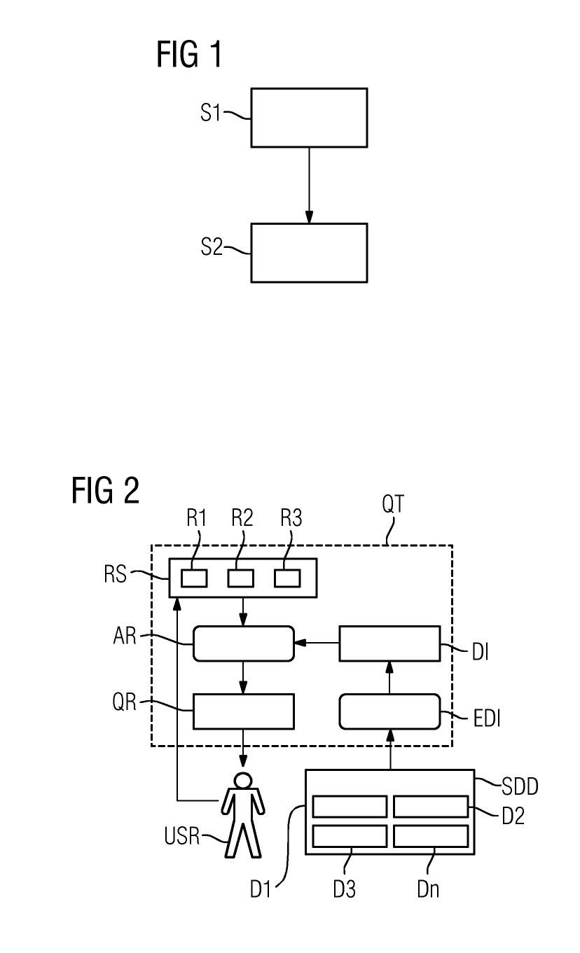

FIG. 1 shows an illustration of a flowchart of a method according to an example embodiment.

The illustrated embodiment provides a method for automatically checking the structure conformity of documents in software systems. The underlying concept of the method is that of identified infringements of defined document structure guidelines, which are reported by an automated checking program, providing inferences as to the formal quality of the documents.

The fundamentals of this embodiment are the rules to be checked and the embedding of said rules into the development process, the criteria for finding the guideline infringements and the elimination of errors.

The method for checking a structure conformity for a piece of development documentation has the two steps.

As a first step, the at least one development document from the development documentation is read in S1 and a document structure for the development document that has been read in is captured by a capture unit A1.

As a second step, discrepancies in the captured document structure from a predetermined document structure are ascertained S2 by a checking unit A2 by using stipulated criteria for checking the structure conformity of the development documentation.

By way of example, the criteria are stipulated by the checking unit A2 or by input from the user or by the respective type of the software system.

FIG. 2 shows an illustration of a program flowchart of the method according to an example embodiment.

Qualitative aspects such as conformity, completeness, freedom from error, readability, availability, or other characteristics of documentation documents are available or measureable naturally only with difficulty. Various international standards, such as NASA documentation standard NASA-STD-2100-91, describe the quality standards of the documentation document.

In addition, the documentation standard used may also be IEEE standard 830-1998, which is a software requirements specification, SRS, and a standard for specifying software that is published by the IEEE, Institute of Electrical and Electronic Engineers, under ANSI/IEEE standard 830-1984.

It is also possible to use the documentation standards ISO/IEC 18019:2004, ISO/IEC 26514:2008, which are geared toward the creation of qualitative software documentation or prescribe explicit documentation guidelines for the creation of software documentation.

By way of example, a quality recognition method QT as shown in FIG. 2 is performed, said quality recognition method QT following the principle of automatically checking the structure conformity of software documents by using a quality standard. In this regard, defined rules R1-R3 combined in a rule set RS are used to prescribe and stipulate criteria. Instead of three rules R1-R3, as shown, it is also possible to use a larger or smaller number of rules.

The rules R1-R3 are set by the user USR, who is active in the function of a project manager or a quality manager, for example. In addition, the rules for the software documentation can be preselected automatically on the basis of a property of the software created.

The software documentation documents D1-Dn are combined in a piece of software documentation or a piece of development documentation SDD. The software documentation documents D1-Dn are extracted from the development documentation SDD by reading EDI. The reading EDI is a method step in the quality recognition method QT.

This provides document information DI, for example for the structure of the software documentation documents D1-Dn from the development documentation SDD.

In addition, the rules R1-R3 are applied AR to this document information DI. As the result of this application AR, the quality recognition method QT delivers information relating to the discrepancies found in the software documentation documents D1-Dn in an evaluation step, denoted by QR.

Three rules R1-R3 which can be applied for checking the structure conformity of software documentation are described by way of example below. These are used by the checking unit A2 as criteria and thus serve as precise specifications for ascertaining rule infringement and also for calculating metrics values.

A possible first rule R1 is designed for observance of a document structure, for example.

The rule R1 checks whether a document corresponds to a particular prescribed structure. Each check on the structure is made on the basis of a template which, by way of example, comprises prescribed sentences and chapters for the document.

If the sentences in the introductory part or the chapters in the main part of a software documentation document do not correspond to the template, this is rated as a discrepancy from the prescribed structure and is documented as a rule infringement for each sentence or each chapter in the software documentation document.

By way of example, there is an infringement of rule R1 if a designation, a minimum or maximum occurrence or an order of the sentences in the introductory part of the document that is to be checked does not match those in the template.

In addition, there is an infringement of rule R1, for example, if a designation, a minimum or maximum occurrence or an order of the chapter labels in the main part of the software documentation document that is to be checked does not match those in the template.

A possible second rule R2 is designed for presence of a version history for the software documentation document, for example.

Every software documentation document must have a version history that describes the changes to the software documentation document in its history.

The version history may be available either as free text or in the form of a table. By way of example, the version history is marked by a particular character string. There is a rule infringement for rule R2 if the entire software documentation document contains no character string which indicates a version history.

By means of configuration, it is possible to stipulate which words need to occur in order to be able to refer to a valid character string for a version history.

By way of example, a simple check is performed on the basis of whether the version history is represented as a table, heading text for a chapter or as free text.

In the case of a table as version history, a check is performed to determine whether the table contains at least one row in which more than half of the cells are filled.

In the case of a heading text for a chapter as version history, a check is performed to determine whether the paragraph after the heading text is not blank.

In the case of free text as version history, a check is performed to determine whether the two subsequent paragraphs are not blank.

By way of example, there is an infringement of rule R2 if there is no version history or if, although there is a version history, it does not correspond to the requirements in terms of structure and content.

A possible third rule R3 is designed for presence of a list of contents for the software documentation document, for example.

Rule R3 does not necessarily check proper layout for the list of contents, such as valid structuring, correct page referencing or the like.

By way of example, the list of contents is arranged in what is known as the introductory part of a software documentation document or in a separate chapter.

There is an infringement of rule R3 if there is no list of contents or if, although there is a list of contents, it does not correspond to the stipulated requirements in terms of structure and content.

Infringements of these rules R1-R3 can subsequently allow inferences as to the quality of the structuring of the documentation.

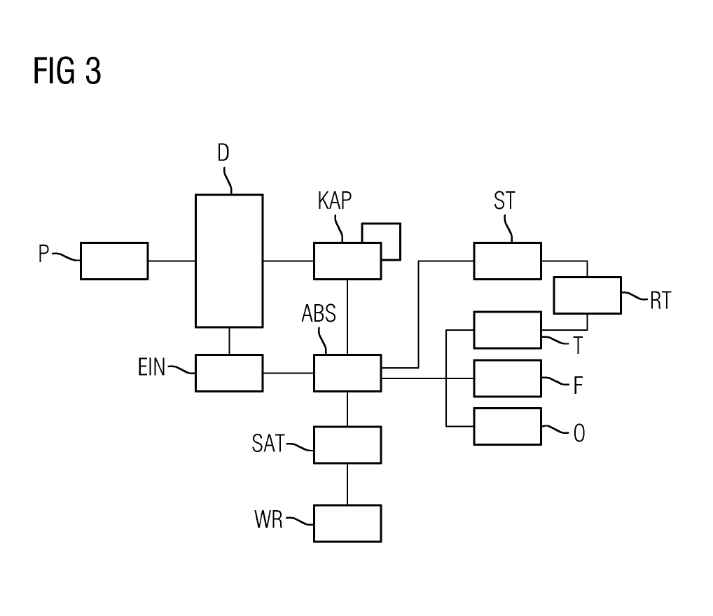

FIG. 3 shows an illustration of a document model of the method according to an example embodiment.

The document model shown in FIG. 3 is a possible logical structure for a software documentation document D and shows how the content of the software documentation document is organized.

The logical structure comprises a multiplicity of logical structure elements. Some examples of logical structure elements are words WR, sentences SAT, paragraphs ABS, chapters KAP, an introduction EIN, figures F, tables T and objects O.

A table column ST comprises both properties which apply only to the column heading and properties which apply to the entire column in the table T.

A table row RT comprises properties which apply to the entire row in the table T.

A hierarchic arrangement of the logical structure elements can still alter the logical document. For example, in the logical document shown in FIG. 3, the tables T are formed from individual paragraphs ABS. In addition, a paragraph ABS can be formed either from at least one sentence SAT, and/or a table T, and/or a figure F and/or an object O.

The software documentation document D is also assigned to a project P in the present hierarchic arrangement of the logical structure elements. The project P is in the form of a project for a software system, for example.

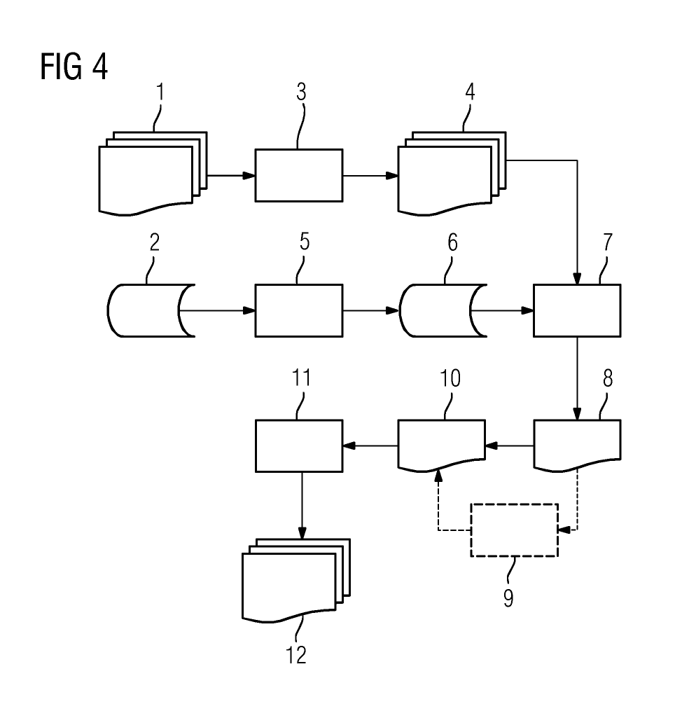

FIG. 4 shows an illustration of a flowchart of a method according to another example embodiment.

In a first flow step 1, the software documentation document D or the development document is automatically transformed. The development documents are automatically converted in a second flow step 3 into a format which allows safe judgment of the structure conformity. This format is detached and independent from/of special features of the formatting, typeface, or similar peculiarities of logical formatting.

The structure conformity is judged by the capture unit A1 in a further flow step 4, for example.

The structure rules are captured by the checking unit A2 in flow steps 2, 5 and 6, for example.

In a further flow step 2, the rules for the structure of the software documentation document are ascertained. By way of example, the individual rules are ascertained in a form that is independent of and separate from one another. By way of example, this involves the rules being distinguished according to the different rule types which are stipulated with a responsible user or with a sub-project manager by software development documents that are to be checked.

In a further flow step 5, the stipulated rules are configured. To this end, a centralized rule manager is implemented in the checking unit A2, for example.

Following the configuration of the rules, a further flow step 6 selects the rules to be applied to the software development document for checking the structure conformity of the software development document.

In a further flow step 7, the configured rules are automatically applied to the software development documents, for example, and, in a further flow step 8, a crude report about infringements found for the requirements regarding the structure of the software development documents is generated, for example.

Optionally, in a further flow step 9, the tasks are manually checked and prioritized, i.e. classified according to priority of tasks to be accomplished for the analysis results.

In addition, it is optionally possible for the results to be checked and for the priorities to be changed in a flow step 10.

Automatic annotation can take place in a further flow step 11, for example.

In a further flow step 12, the checked software development documents can be shown, i.e. the results of the check are automatically integrated into the checked software development documents by taking account of the manual check, see previous point. The result available is therefore the checked software development documents with automatically integrated check results.

FIG. 5 shows an illustration of an apparatus according to an example embodiment.

An apparatus B1 can be used to perform the disclosed method for automatically checking the structure conformity of software development documents.

The apparatus B1 is in the form of a computer. The computer has a screen B2 and an input means B3, which is in the form of a keyboard, for example.

Furthermore, the computer contains a control device B4 which controls the sequences in the computer and particularly the performance of the disclosed method. In particular, the control device B4 contains a processor and a memory which stores a suitable program, i.e. a piece of software, which can be executed by the processor in order to perform the disclosed method.

The control device B4 contains a software memory B5 which stores the software development documents which are intended to have their structure checked, for example. The control device B4 therefore accesses the memory while the software development documents are being checked.

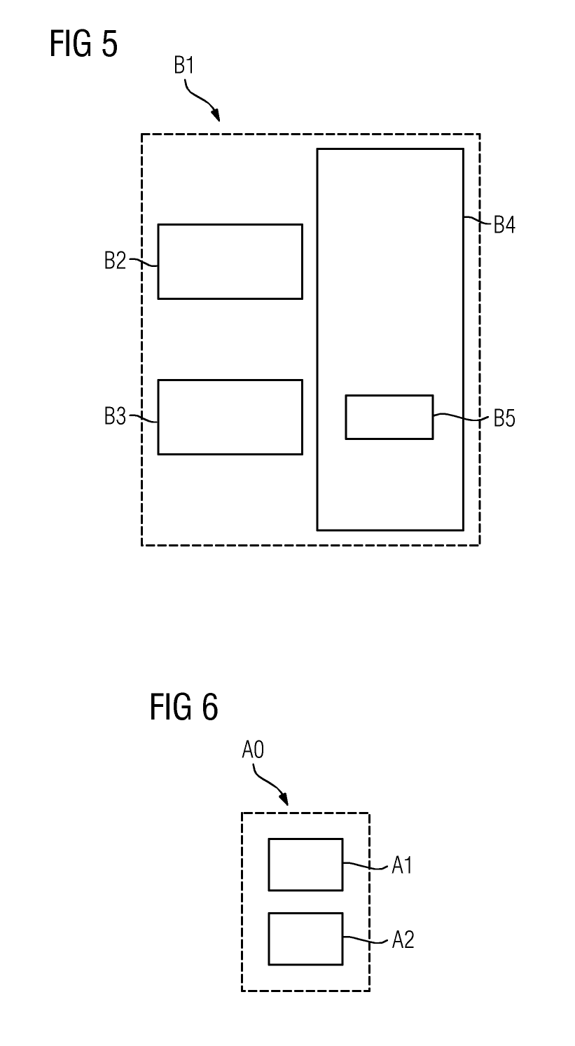

FIG. 6 shows an illustration of an apparatus according to another example embodiment.

An apparatus A0 for checking a structure conformity for a piece of development documentation with at least one development document comprises a capture unit A1 and a checking unit A2.

By way of example, the capture unit A1 is designed to read in the at least one development document from the development documentation and to capture a document structure for the development document that has been read in.

By way of example, the checking unit A2 is designed to ascertain discrepancies in the captured document structure from a predetermined document structure by using prescribed criteria for checking the structure conformity of the development documentation.

What is claimed is:

1. A method for checking a structure conformity for a piece of development documentation with at least one development document, comprising:
reading in the at least one development document from the development documentation,
using a capture device to capture a document structure for the development document that has been read in; and
using a checking device to identify discrepancies in the captured document structure from a predetermined document structure by applying prescribed criteria for checking the structure conformity of the development documentation.

2. The method of claim 1, comprising outputing the identified discrepancies in the captured document structure as an error list using appropriate error messages.

3. The method of claim 1, comprising indicating the identified discrepancies in the captured document structure using annotations in the development document.

4. The method of claim 2, comprising outputing the identified discrepancies in the captured document structure during editing of the development documentation.

5. The method of claim 1, wherein the prescribed criteria comprise a check on a content of the development document.

6. The method of claim 1, wherein the prescribed criteria comprise a check on a version history of the development document.

7. The method of claim 1, wherein the prescribed criteria comprise a check on a list of contents for the development document.

8. The method of claim 1, comprising matching the prescribed criteria for checking with a need for the development documentation.

9. The method of claim 1, wherein the prescribed criteria comprise a check on a structure component of the development document.

10. The method of claim 1, wherein the criteria for checking are selected on the basis of a characteristic of the development documentation.

11. The method of claim 1, wherein the criteria for checking are selected on the basis of a characteristic of a development project associated with the development documentation.

12. The method of claim 1, wherein the predetermined document structure comprises a document structure for a piece of software documentation.

13. An apparatus for checking a structure conformity for a piece of development documentation with at least one development document, having:
a capture device configured to read in the at least one development document from the development documentation and for capturing a document structure for the development document that has been read in; and
a checking device configured to identify discrepancies in the captured document structure from a predetermined document structure by applying stipulated criteria for checking the structure conformity of the development documentation.

14. The apparatus of claim 13, further comprising an output device configured to output the discrepancies found in the form of an error list using appropriate error messages.

15. The apparatus of claim 13, further comprising an output device configured to indicate the discrepancies found in the extracted document structure with annotations in the development document.
